(19) United States
(12) Patent Application Publication
(10) Pub. No.: US 2004/0016590 A1
(43) Pub. Date: Jan. 29, 2004

(54) Electric power steering apparatus

(75) Inventor: Toshiyuki Iwano, Gunma (JP)

Correspondence Address: SUGHRUE MION, PLLC, 2100 Pennsylvania Avenue, NW, Washington, DC, 20037-3213, US

(73) Assignee: NSK LTD.

(21) Appl. No.: 10/401,030

(22) Filed: Mar. 28, 2003

(30) Foreign Application Priority Data
Apr. 18, 2001 (JP) 2001-119099

(51) Int. Cl. B62D 5/04

(52) U.S. Cl. 180/443

(57) ABSTRACT

An electric power steering apparatus having an electric motor for generating steering auxiliary force and a reduction gear device for reducing a rotating speed of the motor by a gear mechanism connected to a rotating shaft of the electric motor, wherein at least one of reduction gears in the gear mechanism is a gear made of a synthetic resin which is lubricated by grease in which lubrication durability at a high temperature is improved while starting torque of rotation at a low temperature is kept low.

### BACKGROUND OF THE INVENTION

1. Field of the Invention

The present invention relates to electric power steering apparatuses which use electric motors and reduction gear devices as steering auxiliary force. Particularly, the present invention relates to an electric power steering apparatus that can be used in a small-sized car having a relatively heavy vehicle front axle load and a grease composition which can embody the apparatus. More particularly, the present invention relates to the electric power steering apparatus and the grease composition in which lubrication fault is hardly generated even when a reduction gear device is placed under a high temperature environment or in a high slipping region.

2. Description of the Prior Art

An electric power steering apparatus using driving force of an electric motor as steering auxiliary force has various advantages such as small fuel consumption and weight reduction due to a small number of constituting components, compared with a hydraulic power steering apparatus.

From a standpoint of mechanism, the electric motor is allowed to be rotated in correspondence with a signal sent from a torque sensor which detects steering torque of a steering shaft and, then, driving force of low torque and high rotation derived from such rotation of the electric motor is transmitted to a steering column or a rack after changed into that of high torque and low rotation via reduction gear device comprising a worm, a worm wheel and the like, thereby assisting steering.

Although there are many cases in which a synthetic resin material is used for a gear, particularly for a worm wheel, of the reduction gear device for the purpose of noise reduction or weight reduction, the synthetic resin material has a fault such that it is inferior in strength or thermal resistance to a metallic gear. Specifically, being based on a tooth shape or a power transmission mechanism, slipping is generated not only in a direction of the tooth shape but also in a direction of a tooth trace whereupon heat is generated by friction to be caused by such slipping, thereby putting a restriction on a service condition of the gear. Further, a high temperature in an operation environment put a great load on the gear made of the synthetic resin. Then, in order to reduce such load put on the gear made of the synthetic resin, lubricant is ordinarily used whereupon grease is in many cases used as the lubricant for the sake of convenience. However, the synthetic resin is ordinarily low in compatibility with grease compared with metal whereupon lubrication fault tends to be generated in the gear made of the synthetic resin even when the grease is applied thereto.

As for a grease composition appropriate for the gear made of the synthetic resin of the electric power steering apparatus, a grease composition is disclosed, for example, in JP-A No. 8-209167 in which a grease, being added with at least one of a fatty acid containing a hydroxyl group and a polyhydric alcohol ester of a fatty acid, is used in the electric power steering apparatus which uses the metallic gear and the resin gear and the like, thereby eliminating the lubrication fault such as oil shortage.

Further, a technique is disclosed in JP-A No. 11-59448 in which, in the electric power steering apparatus which uses the reduction gear device and a rack-pinion mechanism, a traction grease which generates a vitreous solid oil film having a large shear resistance under pressure is applied to at least one of a reduction gear device and the rack-pinion mechanism to reduce abrasion of a gear tooth.

In order to prevent an abnormal wear of the gear made of the synthetic resin, it is necessary that a P·V value specified by a surface pressure P and a slipping velocity V of the gear does not exceed a given upper limit to be defined depending on a material quality or a lubricating state of the gear. However, with regard to the gear made of the synthetic resin, since the compatibility of a synthetic resin with the grease is low, the lubrication fault tends to be generated and, accordingly, a marginal slipping velocity is small. Further, since the synthetic resin is low in compression strength, the upper limit of the surface pressure P of the gear becomes low. As a result, the upper limit of the P·V value becomes low.

Therefore, it is an actual situation that a conventional electric power steering apparatus is mainly adopted in a mini-car in which a vehicle front axle load is relatively light to allow a load to the gear made of the synthetic resin to be small.

Since the electric power steering apparatus has various advantages such as small fuel consumption and weight reduction due to a small number of constituting components, compared with a hydraulic power steering apparatus, it is desired to arrange the electric power steering apparatus also in a small-sized car having a heavier vehicle front axle load than that of the mini-car. That is, development of the electric power steering apparatus which hardly generates a lubrication fault in a high torque region is desired.

Specifically, in the electric power steering apparatus used in the small sized-car having a heavier vehicle front axle load, a high torque motor is used from the necessity of enhancing the steering auxiliary force. In this case, since the surface pressure P of the resin gear becomes large, it is conceivable, in order to decrease this surface pressure P, to enlarge a size of a module of the reduction gear. However, when such enlargement is performed, a diameter of a reference pitch circle of a worm also becomes large simultaneously, thereby increasing the slipping velocity V. Further, it is also conceivable, in order to obtain a large steering auxiliary force, to increase a reduction gear ratio. However, such increase will result in an increase of the slipping velocity V. That is, in order to reduce the surface pressure P and acquire the substantial steering auxiliary force simultaneously, it is necessary to allow the marginal slipping velocity V to be increased in one way or another.

### SUMMARY OF THE INVENTION

Accordingly, an object of the present invention is to improve a marginal slipping velocity at the time of using a reduction gear made of a synthetic resin in a reduction gear device of an electric power steering apparatus. Namely, the object of the invention is to provide the electric power steering apparatus in which, by not generating lubrication fault under a high slipping velocity condition, a reduction gear ratio can be large, steering auxiliary force can be large and durability can also be improved and also to provide a grease composition which can embody the electric power steering apparatus.

Further, in the electric power steering apparatus of a pinion type, it is required to exert performance under a condition of a high temperature environment. Accordingly, an object of the invention is to provide the electric power steering apparatus which can maintain a marginal slipping velocity to be high even under a high temperature environment (for example, 160° C.) inclusive of spontaneous heat generation of a tooth surface of the reduction gear device and also to provide a grease composition which can embody the electric power steering apparatus.

The invention can attain the above-described object by using the grease composition having a specified property in the reduction gear device using a gear made of a synthetic resin of the electric power steering apparatus.

Thus, the invention has been accomplished as described below.

As a first aspect of the invention, there is provided an electric power steering apparatus, comprising:

an electric motor for generating steering auxiliary force; and

a reduction gear device for reducing a rotating speed by a gear mechanism connected to a rotating shaft of the electric motor,

wherein at least one of reduction gears in the gear mechanism is a gear made of a synthetic resin, wherein the gear made of the synthetic resin is lubricated by grease, and wherein the grease is a grease composition in which lubrication durability at a high temperature is improved while a starting torque of rotation at a low temperature is kept low.

As a second aspect of the invention, there is provided an electric power steering apparatus, comprising:

an electric motor for generating steering auxiliary force; and

a reduction gear device for reducing a rotating speed by a gear mechanism connected to a rotating shaft of the electric motor,

wherein at least one of reduction gears in the gear mechanism is a gear made of a synthetic resin, wherein the gear made of the synthetic resin is lubricated by grease, and wherein a degree: X (%) of oil separation of the grease after 100 hours at 160° C. and a low-temperature starting torque: Y (N·cm) of the grease at −40° C. satisfy the following formulas:

3Y≦−10X+140 (1)

0<Y≦30 (2)

As a third aspect of the invention, there is provided the electric power steering apparatus, in which the grease comprises a base oil, a thickening agent and a lubrication-improving agent.

As a fourth aspect of the invention, there is provided the electric power steering apparatus, in which the base oil of the grease is a synthetic hydrocarbon oil, the thickening agent is at least one of a lithium-type complex soap and a urea-type compound, and the lubrication-improving agent is at least one of a solid lubricant and an oily material.

Further, the invention is a grease composition for use in an electric power steering apparatus, in which a degree: X (%) of oil separation of grease after 100 hours at 160° C. and a low-temperature starting torque: Y (N·cm) of the grease at −40° C. satisfy the following formulas:

3Y≦−10X+140

0<Y≦30

Further, the invention is the grease composition for use in the electric power steering apparatus, in which the grease comprises a base oil, a thickening agent and a lubrication-improving agent, or the base oil is a synthetic hydrocarbon oil, the thickening agent is at least one of a lithium-type complex soap and a urea-type compound, and the lubrication-improving agent is at least one of a solid lubricant and an oily material.

### BRIEF DESCRIPTION OF THE DRAWINGS

FIG. 1 is a diagram illustrating a mechanism showing an example of an electric power steering apparatus;

FIG. 2 is a chart showing a relationship between a degree of oil separation and a low-temperature starting torque according to the invention;

FIG. 3 is a schematic diagram of a measuring device of a low-temperature starting torque;

FIG. 4 is a schematic diagram of a testing device for durability; and

FIG. 5 is a graph showing a test result of durability according to the invention.

### DESCRIPTION OF THE PREFERRED EMBODIMENTS

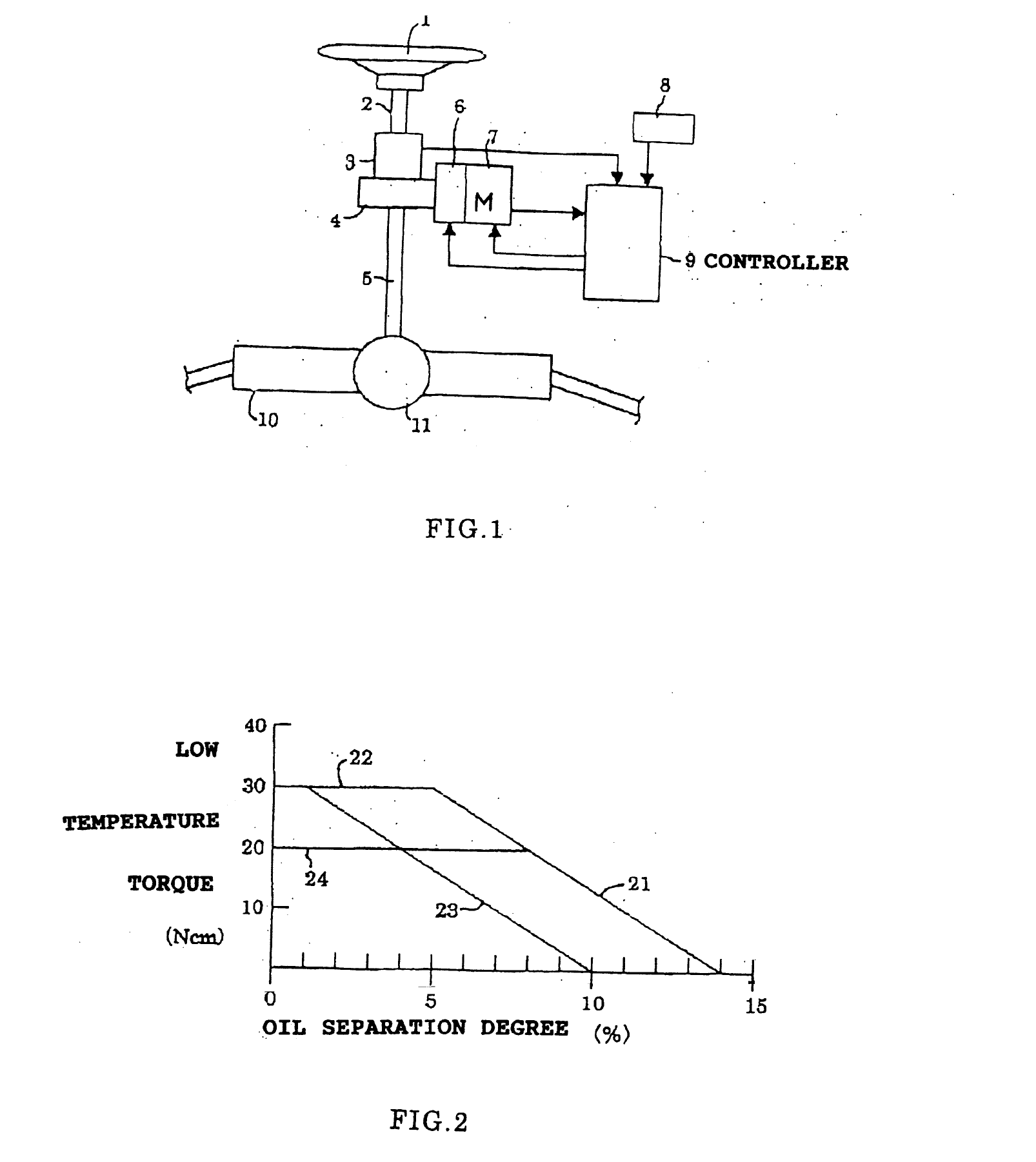

As shown in FIG. 1, a mechanical structure of an electric power steering apparatus according to the present invention comprises an electric motor 7 for generating steering auxiliary force, and a reduction gear device 4 which is capable of reducing a rotating speed by a gear mechanism connected to a rotating axis of the electric motor 7 via a clutch 6. Further, at least one of reduction gears of the gear mechanism is made of a synthetic resin, and such gear made of the synthetic resin is not particularly limited so long as the gear made of the synthetic resin has a known structure which is lubricated by grease.

A shaft 2 of a steering wheel (handle) 1 is connected to a pinion 11 and a rack 10 of a steered wheel via the reduction gear device 4 and a column 5. The shaft 2 is provided with a torque sensor 3 for detecting a steering torque of the steering wheel 1 and a vehicle speed sensor 8 for detecting a vehicle speed. A controller 9 for controlling the electric power steering apparatus is inputted with the steering torque which is detected by the torque sensor 3, the vehicle speed which is detected by the vehicle speed sensor 8 and a detected current of the electric motor 7, thereby controlling a current to be applied to the electric motor 7 based on a steering auxiliary command value computed by the controller 9.

Further, the gear mechanism of the reduction gear device 4 according to the invention is constituted by a combination of a worm and a worm wheel in which the gear made of the synthetic resin is advantageously allowed to be the worm wheel. Furthermore, the gear made of the synthetic resin according to the invention comprises at least one resin selected from the group consisting of: a polyamide resin, a polyamidoimide resin, a polyacetal resin, a polybutylene terephthalate resin, a polyether ether ketone resin, and a polyphenylene sulfide resin whereupon any one of these resins reinforced by glass fibers may also be used.

The grease according to the invention is grease which has improved lubrication durability at a high temperature, while the low-temperature starting torque of rotation is kept low. Further, it is preferable that a degree of oil separation after 100 hours at 160° C.: X(%) and a low-temperature starting torque: Y (N·cm) measured by a low-temperature torque-measuring method at −40° C. satisfy the aforementioned formulas (1) and (2).

Firstly, the formula (1) indicates that it is desirable for the degree of oil separation of grease to be on a left-hand side, namely on a side of smaller value, of a region defined by a broken curved line 21-22 in FIG. 2. FIG. 2 is a graph in which the degree of oil separation (%) and the low-temperature starting torque (N·cm) are plotted in abscissa and ordinate, respectively, whereupon, when consistency of the grease at a given point in FIG. 2 is changed by changing a quantity of a thickening agent, the degree of oil separation and the low-temperature starting torque of the grease tend to move in a direction parallel to the broken curved line 21-22 or 23-24 in FIG. 2. In other words, as the consistency is allowed to be larger, the low-temperature starting torque becomes smaller while the degree of oil separation becomes larger.

However, according to the invention, it was found that it is desirable to allow the degree of oil separation to be small for securing the durability at a high temperature. It is a general tendency that, when the degree of oil separation is unduly small, lubrication fault or abnormal sound of bearing is generated; however, according to the invention, it is desirable, unexpectedly, that the degree of oil separation is small. When the degree of oil separation is in the right-hand side of the broken curved line 21-22 in FIG. 2, the durability of the grease tends to become poor and, further, when the grease is particularly put under the condition that the slipping velocity is 2 m/sec or more, the grease, as a result, tends to have no substantial durability.

More preferably, it is desirable that the degree of oil separation is in a left-hand side of the region defined by the broken curved line 23-24 in FIG. 2. In his case, the formula (1) is replaced by the following formula (3):

3Y≦−10X+100 (3)

On this occasion, the degree of oil separation: X (%) at 160° C. after 100 hours of the grease indicates a value which is obtained by the steps of measuring a quantity of a sample to be dropped in 100 hours at 160° C. in accordance with JIS K 2220 5.7; and expressing weight of the thus-dropped quantity against entire weight of the sample in terms of weight %. Further, the degree of oil separation is desirably 10% or less.

Next, the formula (2) shows that the low-temperature starting torque at −40° C. of the grease is desirably 30 N·cm or less. The reason why the grease is specified by using the low-temperature starting torque is because a low temperature property of the grease which is practically required is specified, while the degree of oil separation specifies a high temperature property of the grease. In the electric power steering apparatus, it is important to allow a difference between a static friction coefficient and a dynamic friction coefficient of a gear part to be as small as possible, so as to suppress a stick-slip phenomenon. Since the stick-slip phenomenon tends to be generated at the time of low temperature by being influenced by viscosity of the grease, it is important to specify the grease by the low-temperature starting torque. That is, the grease is required to satisfy both properties for practical use. As described above, there is a relationship that, when the low-temperature starting torque is adjusted to be small by consistency, the degree of oil separation becomes large.

More preferably, it is desirable that the low-temperature starting torque of the grease is 20 N·cm or less. On this occasion, the formula (2) is replaced by the following formula (4):

0<Y≦20 (4)

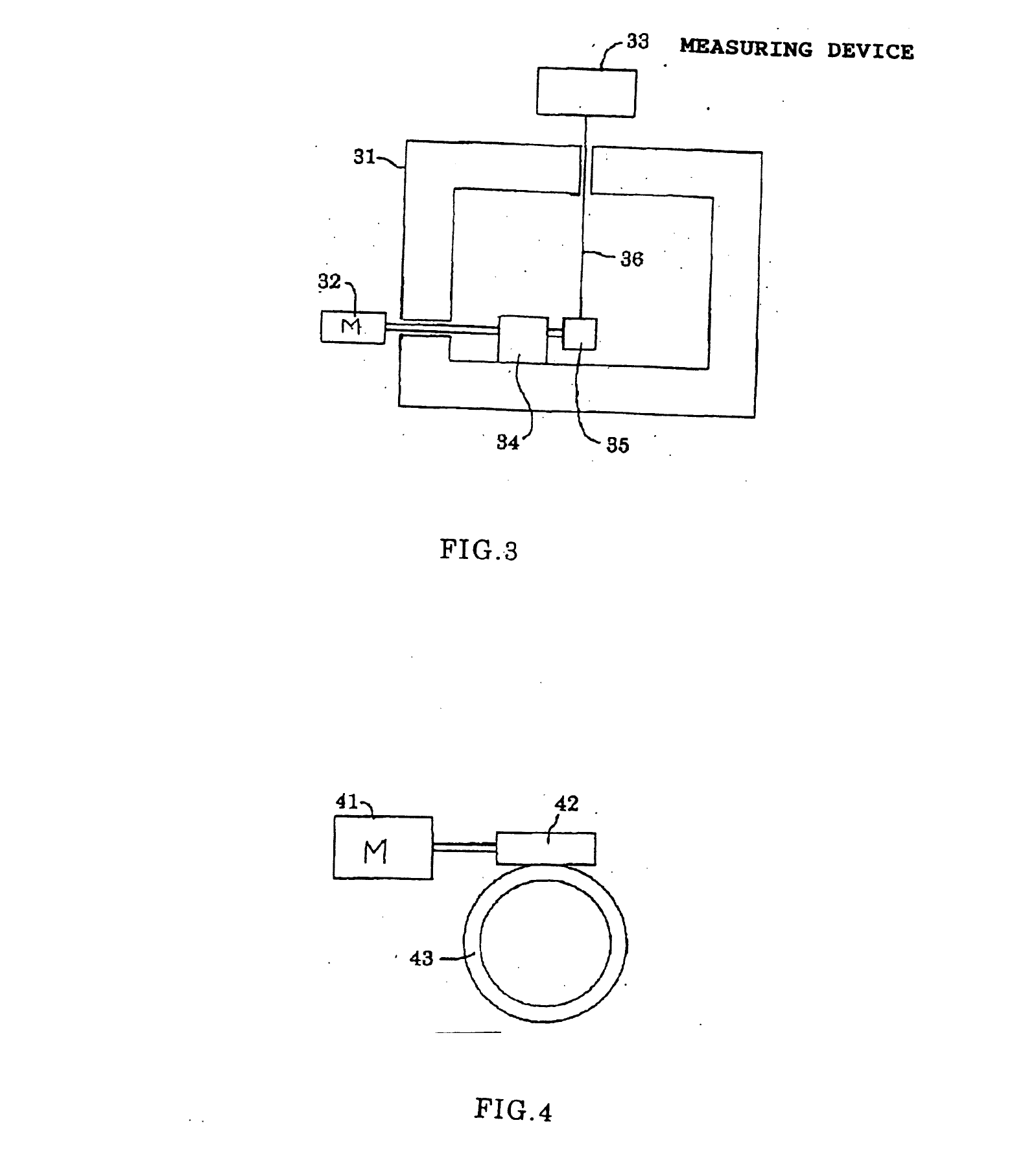

On this occasion, the low-temperature starting torque: Y (N·cm) at −40° C. of the grease is measured by using a low-temperature starting torque-measuring device as shown in FIG. 3, in accordance with a low-temperature torque-testing method specified by JIS K 2220 5.14. That is, a testing tool 35, using a 6204 type ball bearing as a testing bearing, which has been filled with the grease according to the invention, is placed in a cryostat 31 and was, then, rotated by an electric motor 32 at a rate of 1 rpm via reduction gear device 34 at a specified low temperature. Torque of the testing tool 35 is transmitted to a measuring device 33 via thread (or wire) 36 whereupon a maximum starting torque at the rate of 1 rpm can be measured.

It is necessary that the grease according to the invention comprises the lubrication-improving agent, along with the base oil and the thickening agent. By containing the lubrication-improving agent, the grease can unexpectedly satisfy a high temperature property and a low temperature property simultaneously.

As for the base oil of the grease, a synthetic hydrocarbon oil is preferable from the need of satisfying the low temperature property. Specifically mentioned are, for example, poly-α-olefins such as polybutene, a 1-octene oligomer, and a 1-decene oligomer, or hydrogenated products thereof; esters such as butyl stearate, octyl laurate, di-tridecylglutarate, di-2-ethylhexyl adipate, di-isodecyl adipate, di-tridesyl adipate, and di-2-ethylhexyl sebacate; polyol esters such as trimethylolpropane caprylate, trimethylolpropane pelargonate, trimethylolpropane oleate, trimethylolpropane stearate, pentaerythritol-2-ethylhexanoate, pentaerythritol pelargonate, pentaerythritol oleate, and pentaerythritol stearate; others compounds such as an alkylbenzene, an alkyl naphthalene, a polyoxyalkylene glycol, a dialkyl diphenyl ether, and a polyphenyl ether; and mixtures thereof.

As for the viscosity of the base oil, kinetic viscosity thereof at 40° C. is preferably in the range of from 1 mm²/second to 300 mm²/second, more preferably in the range of from 2 mm²/second to 100 mm²/seocnd, and still more preferably in the range of from 2 mm²/second to 20 mm²/second.

As for the thickening agent, a thickening agent selected from the group consisting of: lithium type complex soaps and urea type compounds is used from a viewpoint of satisfying the high temperature property. As for the urea type compounds, any one of an aliphatic urea compound and a cycloaliphatic urea compound is preferable, and an aliphatic diurea compound is more preferable.

A quantity of the thickening agent to be contained is, based on an entire weight of the grease, preferably in the range of from 5% by weight to 25% by weight, more preferably in the range of from 10% by weight to 20% by weight and still more preferably in the range of from 12% by weight to 18% by weight. When the quantity of the thickening agent to be contained is 5% by weight or more, an effect as the thickening agent is performed, whereas when the quantity of the thickening agent to be contained is 25% by weight or less, softness is maintained to exert a lubricating effect.

The consistency of the grease is preferably in the range of from 240 to 320, and more preferably in the range of from 260 to 300. Further, the consistency of the grease was measured in accordance with JIS K 2220 5.3.

The lubrication-improvement agent of the grease is selected from the group consisting of: solid lubricants and oily materials whereupon it may be either any one kind or a mixture of two or more kinds thereof. It is considered that the lubrication-improving agent performs same lubricating action as that of the base oil; however, by incorporating the lubrication-improving agent separately from the base oil, it becomes possible to allow the low temperature torque property to be small, namely, to improve the high temperature property, while the degree of oil separation is kept low.

Examples of such solid lubricants include inorganic substances such as molybdenum disulfide, graphite, Pb, Ag, Au, PbO, and CaF₂; and polymer resins such as a fluorine-containing resin, nylon, and waxes. The term “fluorine-containing resin” as used herein is intended to include a resin, for ordinary use in fluoro-coating and the like, which has a low friction property and non-adhesiveness whereupon specific examples of such fluorine-containing resins include polytetrafluoroethylene (PTFE), fluorinated ethylene propylene copolymer (FEP), tetrafluoroethylene perfluoroalkylvinyl ether copolymer (PFA), ethylene tetrafluoroethylene (ETPE), and poly vinylidene fluoride (PVDF) and, thereamong, polytetrafluoroethylene (PTFE) is preferable. As for the waxes, a long chain fatty acid wax such as a montanic acid wax as a representative example is mentioned and other examples of such waxes include vegetable waxes such as a carnauba wax, and a candelilla wax; animal waxes such as a bees wax, and an insect white wax; and petroleum type waxes such as a paraffin wax whereupon, thereamong, the montanic acid wax is preferable.

Such oily material is a liquid lubricant comprising a molecule, having a polar group at one end thereof, which is a long chain compound having a large molecular weight whereupon examples of such oily materials include mineral oils such as paraffin type mineral oils, naphthene type mineral oils, and aromatic type mineral oils; animal oils such as a whale oil, a beef tallow, and a lard fat; and vegetable oils such as a rapeseed oil, a castor oil, and a palm oil and, thereamong, the castor oil is preferable.

Further, it is preferable that any one of so-called extreme pressure additives such as olefin sulfides, chlorinated paraffins, salts of dialkyl dithiophosphoric acid, salts of dialkyl dithiocarbamic acid, phosphoric esters and the like is further used as the lubrication-improving agent.

A quantity of the lubrication-improving agent to be added is, based on an entire weight of the grease, preferably in the range of from 1% by weight to 20% by weight, more preferably in the range of from 1.0% by weight to 10% by weight and still more preferably in the range of from 1.5% by weight to 5% by weight. Improvement of the low-temperature starting torque can be found when the lubrication-improving agent is added at the rate of 1% by weight or more. Further, strength of the grease is maintained when the lubrication-improving agent is added at the rate of 20% by weight or less.

Further, it is optional to add various types of other additives so long as any effect of the invention is not impaired. Examples of such other additives include antioxidants such as those of an amine type, a phenol type, a sulfur type, and zinc dithiophosphate: rust preventives such as petroleum sulfonate, dinonyl naphthalene sulfonate, and a sorbitan ester; metal deactivators such as benzotriazole, thiadiazole, and sodium nitrite; and viscosity index improving agents such as polymethacrylate, polybutene, and polystyrene.

These other additives may be used either alone or in combinations of two or more types thereof. Further, it is preferable that a quantity of other additives to be added as a whole is, based on an entire weight of the grease, preferably 10% by weight or less.

As for a method for determining the grease composition according to the invention, the base oil and the thickening agent are first decided in correspondence with respective ranges of the consistency and the degree of oil separation and, thereafter, the grease composition may be decided by adjusting the low temperature torque by means of fluctuating a type or a quantity of the lubrication-improving agent. When the type or the quantity of the lubrication-improving agent is fluctuated, the consistency and the degree of oil separation are also fluctuated to some extent. However, a direction of such fluctuation can be expected and an extent of the fluctuation itself is not large; hence, the grease composition can easily be decided.

At the time of producing the grease, it is preferable that, after a mixture of the above-mentioned components is obtained, the thus-obtained mixture is further subjected to kneading processing by using a mill or the like.

Embodiments

An example and a comparative example are given below to further specifically describe the content of the invention and should not be interpreted as limiting it in any way.

### EXAMPLE

80 parts by weight of poly-α-olefin having a kinetic viscosity of 17 mm²/second at 40° C. as a base oil was added with 20 parts by weight of a lithium complex soap, 2 parts by weight of polytetrafluoroethylene and 2 parts by weight of castor oil each as a lubrication-improving agent to prepare a mixture and, then, the thus-prepared mixture was uniformly dispersed by using a homogenizer and, further, agitated at 200° C. for 2 hours and, after being cooled, subjected to kneading processing by using a 3-roll mill to obtain grease. When a degree of oil separation, a low temperature torque and consistency of the thus-obtained grease were measured, the degree of oil separation, the low temperature torque and the consistency thereof were 9.6%, 19 N·cm and 280, respectively.

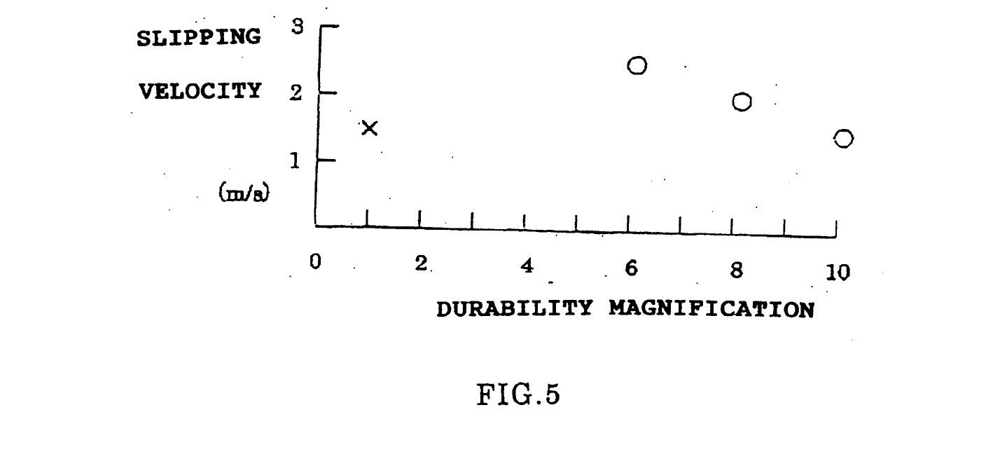

Next, the thus-obtained grease was applied to a worm wheel 43 of a device shown in FIG. 4 and, then, subjected to a durability test under three different slipping velocity conditions of 1.5 m/s, 2.0 m/s and 2.5 m/s. On this occasion, a worm 42 was made of steel, and the worm wheel 43 was made of a nylon 6 resin reinforced with 30% of glass fibers. An angle of rotation of the worm 42 was measured, when the worm wheel 43 was fixed every predetermined rotations and, then, a predetermined torque was applied to a shaft of the worm 42 which was rotated by an electric motor 41. A point of inflection at which the angle was rapidly increased was set as a durability limit. The results are shown as “O” marks in FIG. 5. In FIG. 5, the durability was displayed in terms of magnification against a number of times of durability at the time of using the grease of Comparative Example. The grease according to the invention showed excellent durability not only in a region in which the slipping velocity was small but also in a region in which the slipping velocity is large. COMPARISON:

### COMPARATIVE EXAMPLE

78 parts by weight of poly-α-olefin having a kinetic viscosity of 17 mm²/second at 40° C. as a base oil was added with 13 parts by weight of a lithium complex soap as a thickening agent, 6 parts by weight of hexaglyceryl polyricinolate, and 3 parts by weight of a phenolic antioxidant to produce grease. When the degree of oil separation, the low temperature torque and the consistency of the thus-produced grease were measured in a same manner as in Example, the degree of oil separation, the low-temperature starting torque, and the consistency were 16.2%, 29 N·cm, and 280, respectively. Then, the durability test was performed in a same manner as in Example. The result is shown as an “x” mark in FIG. 5. The result indicates that, even when the slipping velocity was allowed to be small, the durability was not noticed.

According to the invention, the electric power steering apparatus excellent in durability which, even when a reduction gear ratio is set to be large, hardly generates abnormal wear of the gear and can obtain large steering auxiliary force can be obtained.

What is claimed is:

1. An electric power steering apparatus, comprising:
an electric motor for generating steering auxiliary force; and
a reduction gear device for reducing a rotating speed by a gear mechanism connected to a rotating shaft of the electric motor,
wherein at least one of reduction gears in the gear mechanism is a gear made of a synthetic resin, wherein the gear made of the synthetic resin is lubricated by grease, and wherein the grease is a grease composition in which lubrication durability at a high temperature is improved while a starting torque of rotation at a low temperature is kept low.

2. An electric power steering apparatus, comprising:
an electric motor for generating steering auxiliary force; and
a reduction gear device for reducing a rotating speed by a gear mechanism connected to a rotating shaft of the electric motor,
wherein at least one of reduction gears in the gear mechanism is a gear made of a synthetic resin, wherein the gear made of the synthetic resin is lubricated by grease, and wherein a degree: X (%) of oil separation of the grease after 100 hours at 160° C. and a low-temperature starting torque: Y (N·cm) of the grease at −40° C. satisfy the following formulas:
3Y≦−10X+140
0<Y≦30

3. The electric power steering apparatus as set forth in claim 2, wherein the grease comprises a base oil, a thickening agent and a lubrication-improving agent.

4. The electric power steering apparatus as set forth in claim 3, wherein the base oil of the grease is a synthetic hydrocarbon oil, the thickening agent is at least one of a lithium-type complex soap and a urea-type compound, and the lubrication-improving agent is at least one of a solid lubricant and an oily material.

5. The electric power steering apparatus as set forth in claim 2, wherein the formulas can be replaced by a pair of formulas selected from the group consisting of: 3Y≦−10X+100 and 0<Y≦30, 3Y≦−10X+140 and 0<Y≦20, and 3Y≦−10X+100 and 0<Y≦20.

6. The electric power steering apparatus as set forth in claim 4, wherein a kinetic viscosity of the base oil at 40° C. in the range of from 1 mm²/sec to 300 mm²/sec.

7. The electric power steering apparatus as set forth in claim 4, wherein a kinetic viscosity of the base oil at 40° C. is in the range of from 2 mm²/sec to 100 mm²/sec.

8. The electric power steering apparatus as set forth in claim 4, wherein the thickening agent is an aliphatic diurea compound.

9. The electric power steering apparatus as set forth in claim 4, wherein a quantity of the thickening agent to be contained is, based on an entire weight of the grease, in the range of from 5% by weight to 25% by weight.

10. The electric power steering apparatus as set forth in claim 2, wherein consistency of the grease is in the range of from 240 to 320.

11. A grease composition for use in an electric power steering apparatus, wherein a degree: X (%) of oil separation of grease after 100 hours at 160° C. and a low-temperature starting torque: Y (N·cm) of the grease at −40° C. satisfy the following formulas:
3Y≦−10X+140
0<Y≦30

12. The grease composition for use in the electric power steering apparatus as set forth in claim 11, wherein the grease comprises a base oil, a thickening agent and a lubrication-improving agent.

13. The grease composition for use in the electric power steering apparatus as set forth in claim 12, wherein the base oil is a synthetic hydrocarbon oil, the thickening agent is at least one of a lithium-type complex soap and a urea-type compound, and the lubrication-improving agent is at least one of a solid lubricant and an oily material.
